(19) United States
(12) Patent Application Publication
(10) Pub. No.: US 2025/0365689 A1
(43) Pub. Date: Nov. 27, 2025

(54) SYSTEM AND METHOD FOR PROVIDING AN EXTERNAL IDENTIFICATION TO A USER EQUIPMENT

(71) Applicant: QUALCOMM Incorporated, San Diego, CA (US)

(72) Inventors: Nishant GUPTA, Bangalore (IN); Alan SOLOWAY, Frederick, CO (US); Dario Serafino TONESI, San Diego, CA (US); Sunghoon KIM, San Diego, CA (US); Tom CHIN, San Diego, CA (US); Adrian Edward ESCOTT, Reading (GB)

(21) Appl. No.: 18/875,056

(22) PCT Filed: Aug. 7, 2023
(86) PCT No.: PCT/US2023/029640

§ 371 Date: Dec. 13, 2024

(30) Foreign Application Priority Data
Aug. 10, 2022 (IN) 202241045725

(51) Int. Cl. H04W 60/04; H04W 12/0433; H04W 12/06; H04W 76/10

(52) U.S. Cl. CPC H04W 60/04; H04W 12/0433; H04W 12/06; H04W 76/10

(57) ABSTRACT

Certain aspects of the present disclosure provide techniques for a user equipment (UE) requesting for a UE ID. Particular aspects provide for a method for wireless communication performed by a UE. The method generally includes transmitting a registration request to a core network, receiving an external identifier from the core network, transmitting the external identifier to an application client at the UE, and invoking capability of the core network using the external identifier.

### CROSS-REFERENCE TO RELATED APPLICATION(S)

This application claims benefit of and priority to Indian Application No. 202241045725, filed Aug. 10, 2022, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for providing a user equipment (UE) identifier (ID) to the UE.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multiple access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that improve public identification of a UE.

As described herein, a UE may not know its external ID, even when one is allotted to it. Sharing certain IDs (e.g., a Mobile Station International Subscriber Directory Number (MSISDN) to an Application Function (AF)) has privacy concerns. By knowing and using an external ID, the UE may share it with AFs reducing privacy concerns associated with sharing other IDs, such as the MSISDN.

Certain aspects can be implemented in a method for wireless communication by a UE. The method generally includes transmitting a request to a core network, receiving an external identifier (e.g., a Generic Public Subscription Identifier (GPSI)) from the core network in response to the request, transmitting the GPSI to an application client at the UE, and invoking capability of the core network (CN) using the GPSI.

Other aspects can be implemented in a method for wireless communication by a UE. The method generally includes transmitting an application layer request to an AF, (the AF receiving an external identifier (e.g., GPSI) from a Network Exposure Function (NEF) of a CN), and the UE receiving an application layer response including external identifier (e.g., the GPSI) from the AF.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in this application by illustration to some examples, those skilled in the art will understand that additional examples and use cases may come about in many different arrangements and scenarios. Aspects described herein may be implemented across many differing platform types, devices, systems, shapes, sizes, packaging arrangements. For example, aspects and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described aspects may occur. Implementations may range in spectrum from chip-level or modular components to non-modular, non-chip-level implementations and further to aggregate, distributed, or original equipment manufacturer (OEM) devices or systems incorporating one or more of the aspects described. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, end-user devices, etc. of varying sizes, shapes, and constitution.

The following description and the appended figures set forth certain features for purposes of illustration.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. The appended drawings illustrate only certain aspects of this disclosure and are therefore not to be considered limiting, for the description may admit to other equally effective aspects.

FIG. 1 depicts an example wireless communications network.

FIG. 2A-2D each illustrates an example logical architecture.

FIG. 3 depicts aspects of an example base station and user equipment.

FIGS. 4A-4B depict an example call flow for obtaining an edge specific external identifier, in accordance with aspects of the present disclosure.

FIGS. 5A-5B is an example call flow for a UE requesting a UE ID during UE registration, in accordance with aspects of the present disclosure.

FIGS. 6A-6B is another example call flow for a UE requesting a UE ID during UE registration, in accordance with aspects of the present disclosure.

FIGS. 7A-7B is an example call flow for a UE requesting a UE ID during protocol data unit (PDU) session establishment, in accordance with aspects of the present disclosure.

FIG. 8 illustrates procedure of a UE requesting a UE ID using a service level authentication and authorization (AA) procedure, in accordance with aspects of the present disclosure.

FIG. 9 is an example call flow for a UE requesting a UE ID using a service level AA procedure, in accordance with aspects of the present disclosure.

FIG. 10 is an example call flow for assigning a UE ID during an Authentication and Key Management for Applications (AKMA) procedure, in accordance with aspects of the present disclosure.

FIG. 11 is an example call for verifying UE provided GPSI, in accordance with aspects of the present disclosure.

FIG. 12 is an example call flow for verifying UE provided GPSI in an edge enabler server (EES), in accordance with aspects of the present disclosure.

FIG. 13 is an example call flow for verifying UE provided GPSI in a CN, in accordance with aspects of the present disclosure.

FIG. 14 is an example call flow for an AF to retrieve a UE ID from the CN based on inputs provided by the UE, in accordance with aspects of the present disclosure.

FIG. 15 is an example call flow for an AF to retrieve the UE ID from the Unified Data Management (UDM) function of the CN based on inputs provided by the UE, in accordance with aspects of the present disclosure.

FIG. 16 is a flow diagram depicting example operations for a UE requesting a UE ID, in accordance with aspects of the present disclosure.

FIG. 17 is another flow diagram depicting example operations for a UE requesting UE ID, in accordance with aspects of the present disclosure.

FIG. 18 is an example communications device, in accordance with aspect of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for a UE to obtain an external identifier of the UE. As described herein, a UE may not know its external ID, in some cases, despite the external ID being allotted to the UE.

Sharing certain IDs (e.g., sharing an MSISDN to an AF) has privacy concerns. By obtaining an external ID of the UE, the UE may share it with an AF, reducing privacy concerns associated with sharing other IDs, such as the MSISDN.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

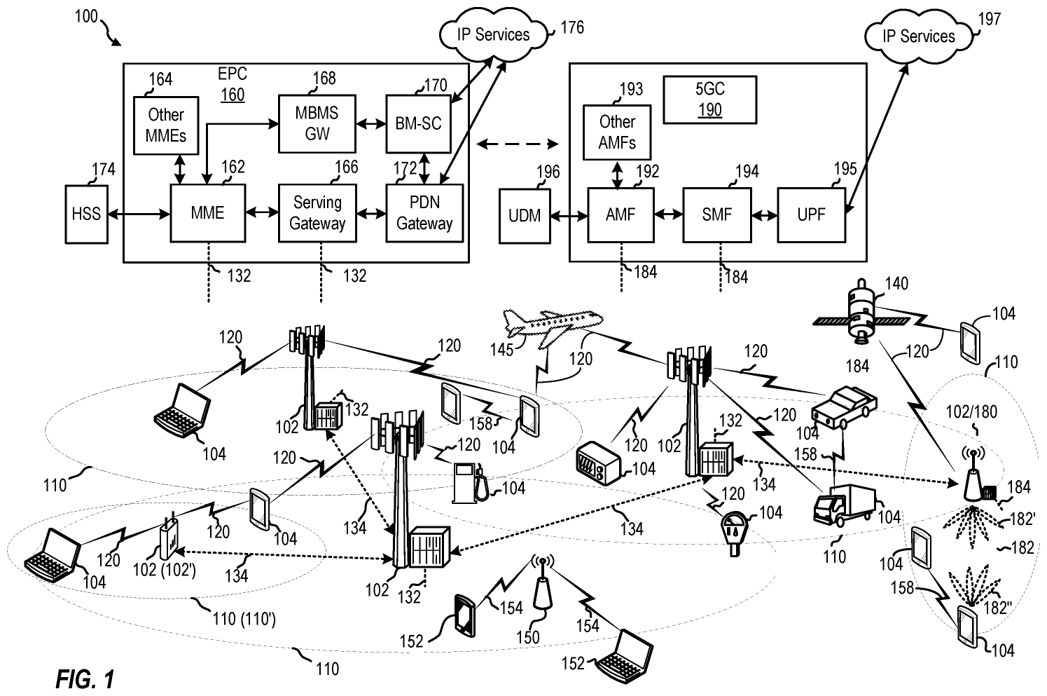

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a UE, a BS, a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use MIMO antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS 102 may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a base station including components that are located at various physical locations may be referred to as a disaggregated radio access network architecture, such as an Open RAN (O-RAN) or Virtualized RAN (VRAN) architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with UDM 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated BS, as a disaggregated BS, a component of a BS, an integrated access and backhaul (IAB) node, a relay node, a sidelink node, to name a few examples.

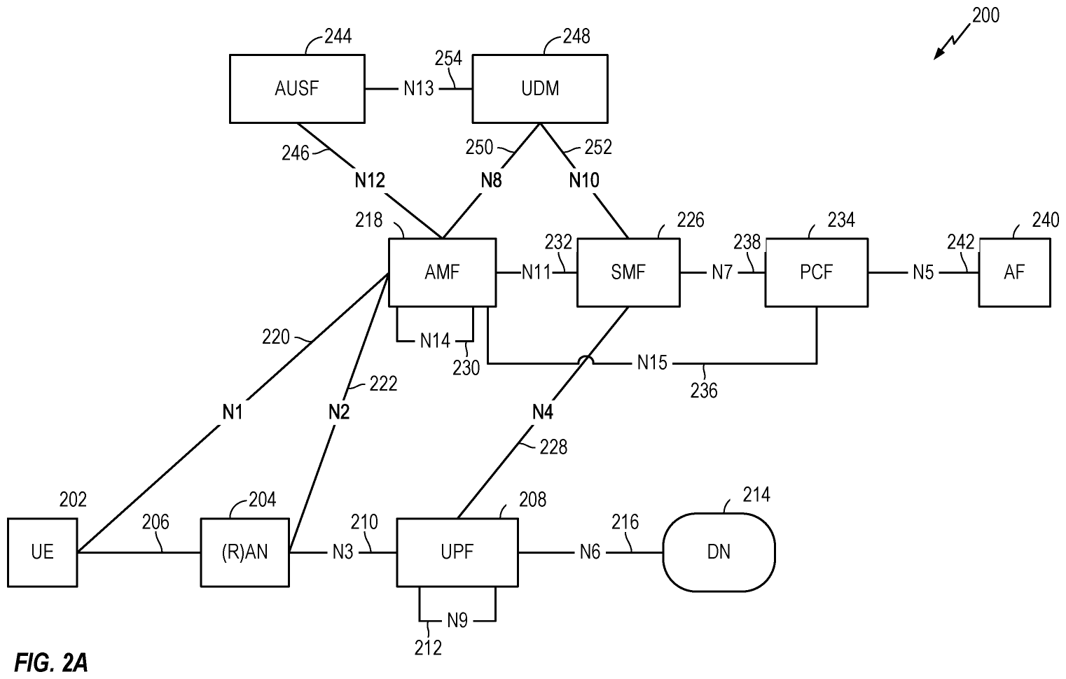

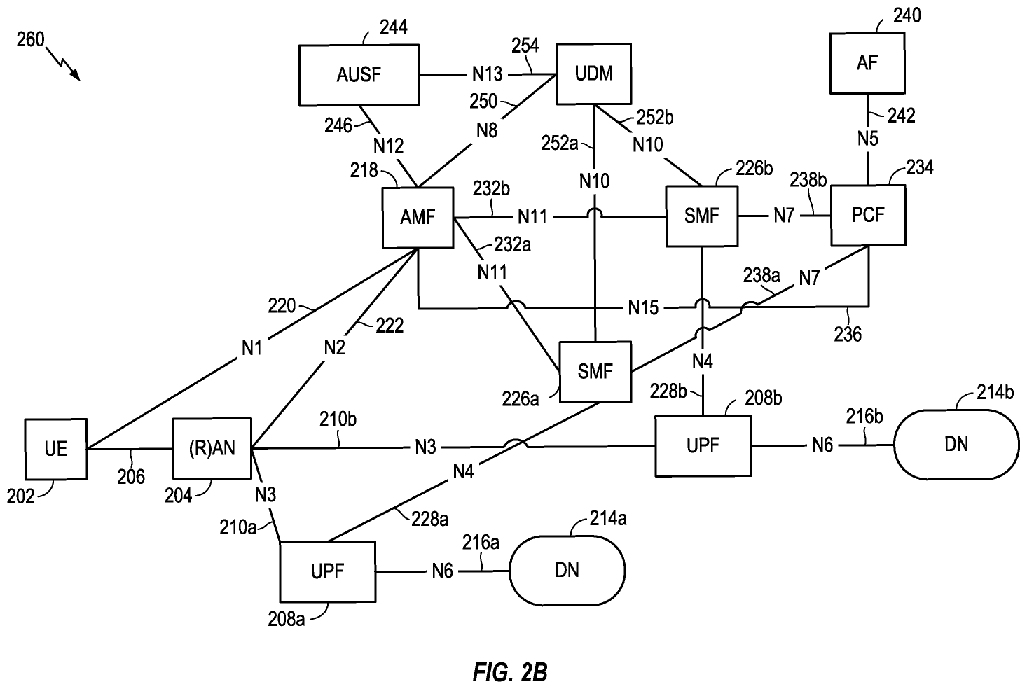

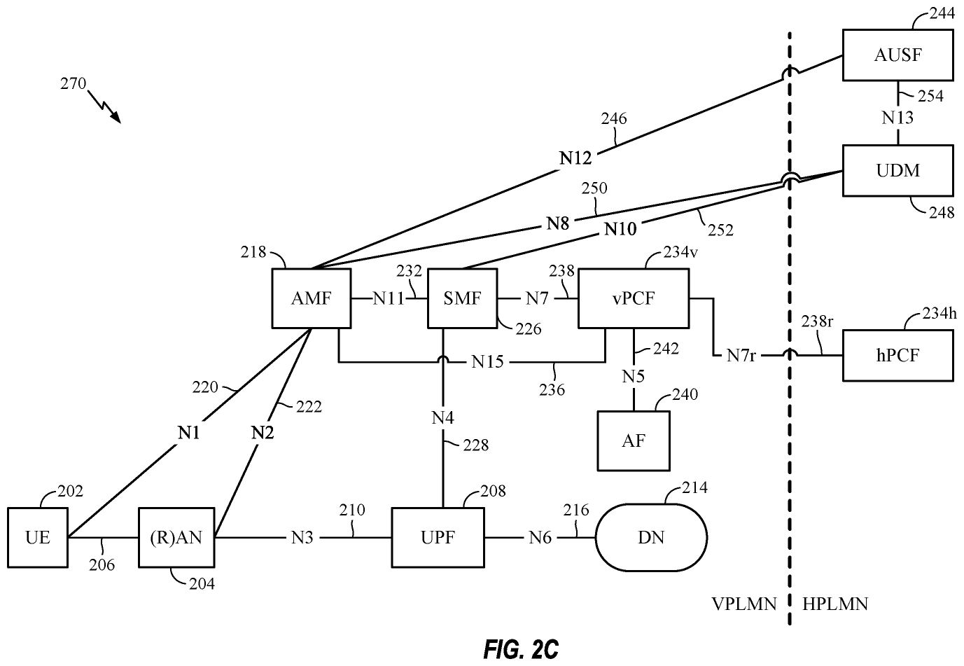

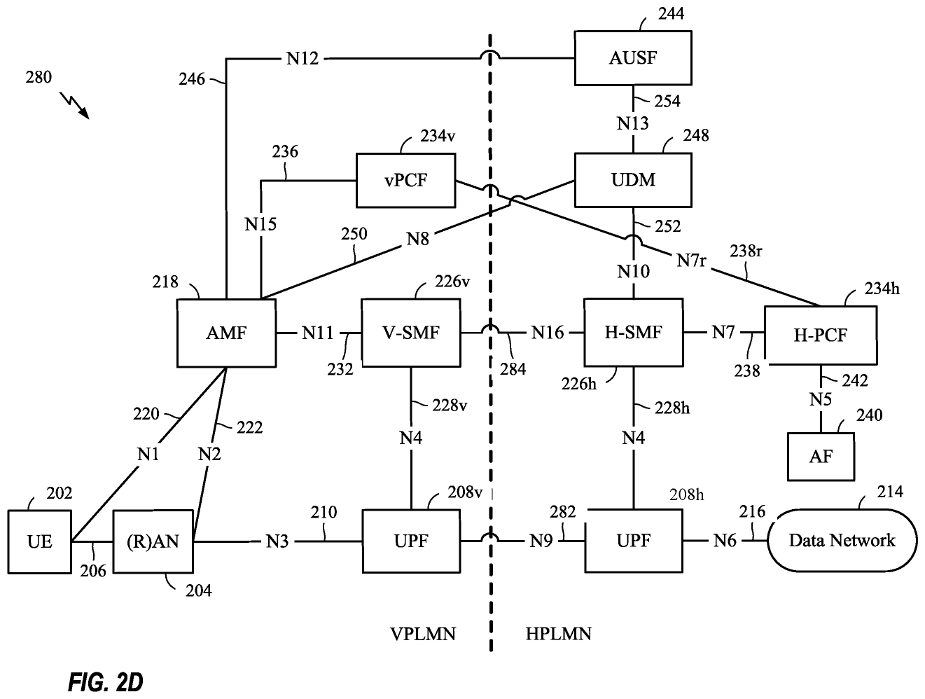

FIG. 2A illustrates an example logical architecture 200 of a NR RAN, which may be implemented in the wireless communication system illustrated in FIG. 1. A UE 202 may access a RAN 204 via an NR air interface 206. The RAN may communicate with a UPF 208 via an N3 interface 210. Communications between different UPFs 208 may be conveyed via an N9 interface 212. The UPFs may communicate with a data network (DN) 214 (e.g., the Internet, network-operator-provided services) via one or more N6 interfaces 216. The UE may communicate with one or more core AMFs 218 via an N1 interface 220. The RAN may communicate with the one or more AMFs via an N2 interface 222. The UPFs may communicate with a SMF 226 via an N4 interface 228.

Communications between different AMFs 218 may be conveyed via an N14 interface 230. The AMFs may communicate with the SMF 226 via an N11 interface 232. The AMFs may communicate with a policy control function (PCF) 234 via an N15 interface 236. The SMF may communicate with the PCF via an N7 interface 238. The PCF may communicate with an AF 240 via an N5 interface 242. The AMFs may communicate with an authentication server function (AUSF) 244 via an N12 interface 246. The AMFs may communicate with a UDM 248 via an N8 interface 250. The SMF may communicate with the UDM via an N10 interface 252. The AUSF may communicate with the UDM via an N13 interface 254.

While the example architecture 200 illustrates a single UE, the present disclosure is not so limited, and the architecture may accommodate any number of UEs. Similarly, the architecture shows the UE accessing a single DN, but the present disclosure is not so limited, and the architecture accommodates a UE communicating with a plurality of DNs, as described below with reference to FIG. 2B.

FIG. 2B illustrates an example logical architecture 260 of a NR RAN, which may be implemented in the wireless communication system illustrated in FIG. 1. The logical architecture 260 is similar to the logical architecture 200 shown in FIG. 2A, with many of the same entities shown and labeled with the same labels. Thus, only differences from FIG. 2A will be described. The UE 202 in FIG. 2B is accessing two DNs, 214a and 214b, via the RAN 204. The RAN communicates with a first UPF 208a via a first N3 interface 210a. The RAN also communicates with a second UPF 208b via a second N3 interface 210b. Each UPF communicates with a corresponding DN 214a or 214b via a corresponding N6 interface 216a or 216b. Similarly, each UPF communicates with a corresponding SMF 226a or 226b via a corresponding N4 interface 228a or 228b. Each SMF communicates with the AMF 218 via a corresponding N11 interface 232a or 232b. Similarly, each SMF communicates with the PCF via a corresponding N7 interface 238a or 238b.

FIG. 2C illustrates an example logical architecture 270 of a NR RAN, which may be implemented in the wireless communication system illustrated in FIG. 1. The logical architecture 270 is similar to the logical architecture 200 shown in FIG. 2A, with many of the same entities shown and labeled with the same labels. Thus, only differences from FIG. 2A will be described. In the logical architecture 270, the UE 202 is roaming, and is therefore connected with the home physical land mobile network (HPLMN) of the UE 202 via certain entities in the visited physical land mobile network (VPLMN). In particular, the SMF communicates with the VPLMN PCF (vPCF) 234v, but some policy information regarding the UE's access to the DN 214 may be retrieved from the HPLMN PCF (hPCF) 234h via a roaming N7r interface 238r. In FIG. 2C, the UE 202 is able to access the DN 214 via the VPLMN.

FIG. 2D illustrates an example logical architecture 280 of a NR RAN, which may be implemented in the wireless communication system illustrated in FIG. 1. The logical architecture 280 is similar to the logical architecture 270 shown in FIG. 2C, with many of the same entities shown and labeled with the same labels. Thus, only differences from FIG. 2C will be described. In the logical architecture 280, the UE 202 is roaming and is, therefore, connected with the HPLMN of the UE 202 via certain entities in the VPLMN. Unlike FIG. 2C, the UE 202 in FIG. 2D is accessing a DN 214 that the UE 202 is not able to access via the VPLMN. Unlike in FIG. 2C, the UPF 208v in the VPLMN communicates with the VPLMN SMF (V-SMF) 226v via an N4 interface 228v, while the UPF 208h in the HPLMN communicates with the HPLMN SMF (H-SMF) 226h via an N4 interface 228h. The UPF 208v of the VPLMN communicates with the UPF 208h of the HPLMN via an N9 interface 282. Similarly, the V-SMF 226v communicates with the H-SMF 226h via an N16 interface 284.

Operations performed and protocols used by the various entities shown in the example logical architectures 200, 260, 270, and 280 in FIGS. 2A-2D are described in more detail in documents “TS 23.501; System Architecture for the 5G System; Stage 2 (Release 15)” and “TS 23.502; Procedures for the 5G System; Stage 2 (Release 15),” both of which are publicly available.

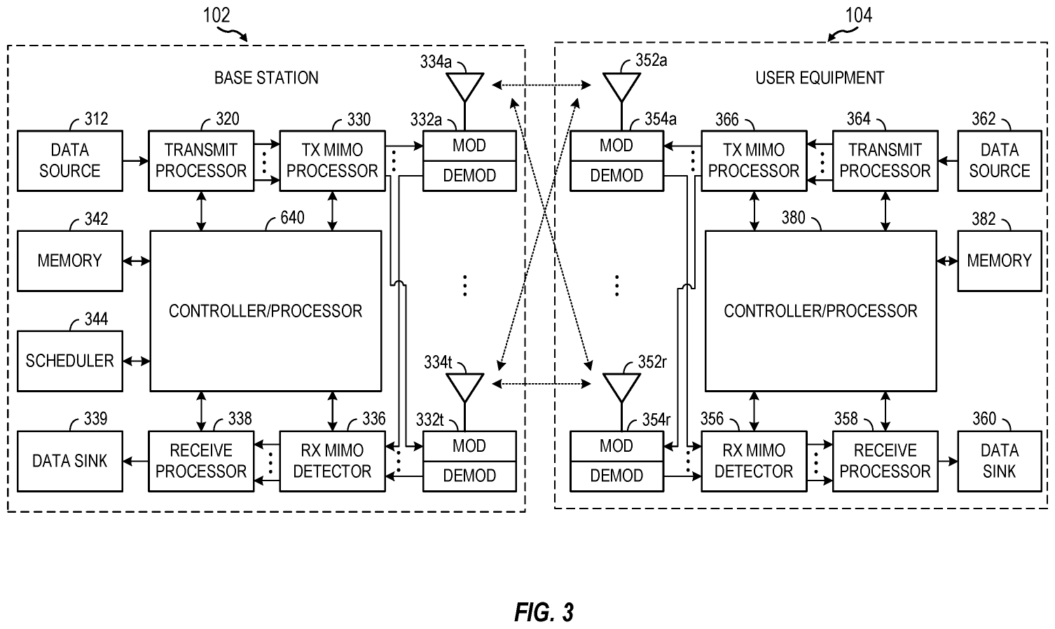

FIG. 3 depicts aspects of an example BS 102 and an example UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) MIMO processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

### Example Methods to Provide a UE ID to a UE

A UE may be publically identified using a GPSI. One example type of GPSI is an MSISDN (e.g., the mobile number). Another type of GPSI is an External ID. The External ID may have a format <id>@<domain>. GPSIs can be used by AFs to invoke CN capability exposure application programing interfaces (APIs) for specific UEs. For example, an AF may invoke the CN API to retrieve a location of a UE.

The AFs may obtain the GPSI from the mobile network operator (MNO), for example based on service level agreements. One example is the Nnef_UEId_Get method exposed by the NEF (and which does not support network address translation (NAT)). AFs may obtain the GPSI from the UE when the UE knows its GPSI.

A UE may know the MSISDN (if it has one) but the UE may not know its External ID (even when one is allotted to the UE). A UE sharing its MSISDN with the AF, however, has privacy concerns. Accordingly, the UE may share its External ID with the AF, however, there is no standard way to provide the External ID to the UE so that the UE can share the External ID with the AF. Therefore, there is a desire to provide the External ID(s) to the UE so that the UE can provide the External ID to the AF without compromising UE privacy.

According to aspects of the present disclosure, a new UE External ID is defined. While aspects of the disclosure are discussed with respect to requesting, providing, and using the external ID, the techniques discussed herein may be used for requesting, providing, and using any type of UE ID. In some aspects, the new External ID of the UE is an edge computing specific external ID (E-GPSI). The E-GPSI is designed to avoid privacy issues. In some aspects, only edge enabler layer entities (e.g., such as the EES and edge configuration server (ECS)) are expected to use the E-GPSI. In some aspects, a list of E-GPSIs are stored to avoid tracking of UEs across edge computing service providers (ECSPs). In some aspects, one E-GPSI is assigned per ECSP.

According to aspects of the present disclosure, AF information and/or service information related to the External ID (e.g., the E-GPSI) are stored in the UDM (e.g., in addition to the stored list of E-GPSIs). The AF information and/or service information may include information of the services and/or AFs authorized to use a corresponding External ID (e.g., the E-GPSI). In some aspects, the AF and/or service information is shared with the UE. In some aspects, the UE uses the AF and/or service information to determine which External ID (e.g., the E-GPSI) corresponds to which service, AF, and/or ECSP.

According to aspects of the present disclosure, the UE provides the External ID (e.g., the E-GPSI) and the service/AF information (e.g., the ECSP information) to the correct AF (e.g., to an EES/ECS belonging to the correct ECSP).

While aspects are described with reference to edge computing and the UE's edge computing specific External ID is referred to as an E-GPSI, the aspects are not limited to edge computing or an E-GPSI. Additionally, the methods described herein can be used to provide a UE ID for any or all services requested by the UE.

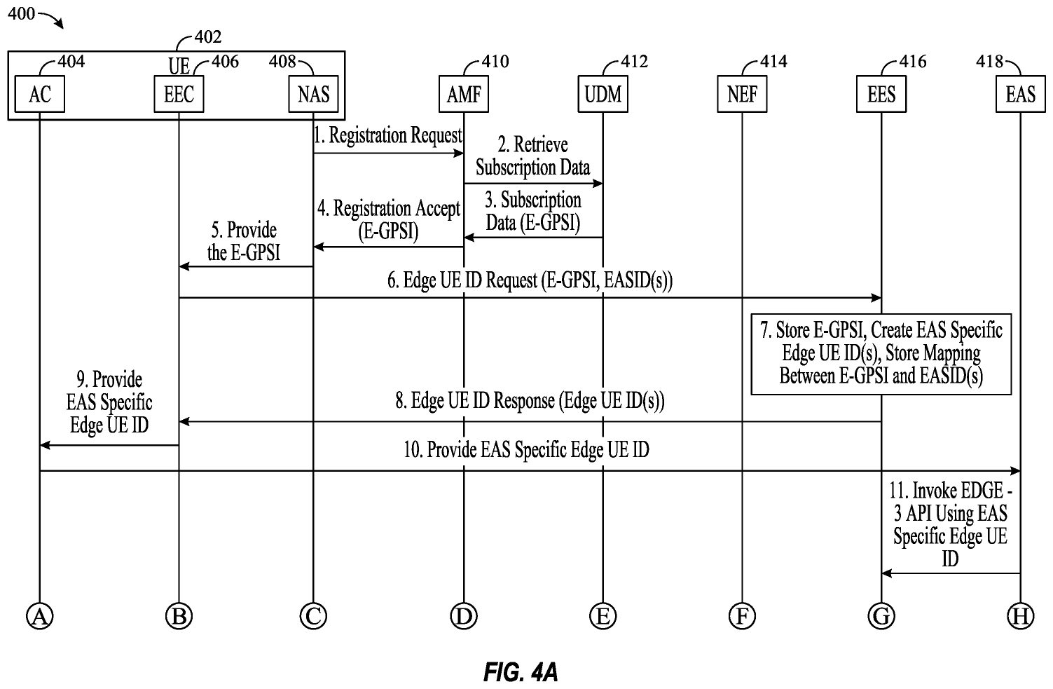

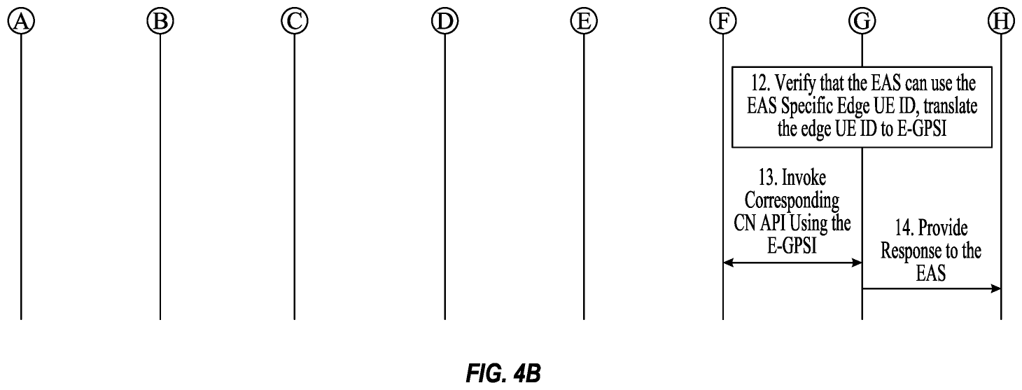

FIGS. 4A-4B is an example call flow diagram of a procedure 400 for obtaining an E-GPSI, in accordance with aspects of the present disclosure.

According to certain aspects, the MNO creates an E-GPSI for UE 402 when the UE 402 subscribes for edge enabler layer (EEL) services and stores the E-GPSI in the UDM 412. As shown in FIGS. 4A-4B, at step 1, the UE 402 (e.g., a UE 104 or a UE 202 as depicted in FIGS. 1-3) transmits a registration request message to the AMF 410 (e.g., via the non-access stratum (NAS) layer 408). At step 2, the AMF 410 retrieves subscription data from the UDM 412. At step 3, the UDM 412 returns the subscription data, including the E-GPSI, to the AMF 410. At step 4, the AMF 410 transmits a registration accept message, including the E-GPSI, to the UE 402. At step 5, the E-GPSI is forwarded (e.g., by the NAs layer 408 of the UE 402) to an Edge Enabler Client (EEC) 406 of the UE 402.

According to certain aspects, the EEC 406, via the EES 416, receives the E-GPSI translated to an edge application specific (EAS) UE ID. As shown in FIGS. 4A-4B, at step 6, the EEC 406 sends an Edge UE ID request (e.g., including the E-GPSI and requesting an EAS ID) to the EES 416. At step 7, EES 416 stores the E-GPSI, creates one or more EAS IDs, and stores a mapping between the E-GPSI and the one or more EAS IDs. At step 8, the EES 416 provides the EAS ID(s) to the EEC 406. At step 9, the EEC 406 forwards the EAS ID(s) to the application client (AC) 404. At step 10, the AC 404 provides EAS ID(s) to the EAS 418.

At step 11, the EAS 418 uses the EAS ID(s) to invoke an EDGE-3 API via the EES 416. At step 12, the EES 416 translates the EAS ID(s) to the corresponding E-GPSI and uses the E-GPSI to invoke a corresponding CN capability API via the NEF 414. At step 14, the EES 416 transmits a response to the EAS 418.

In FIGS. 4A-4B, the UE 402 receives a single E-GPSI; however, in aspects, a UE may be provided with multiple UE IDs.

### UE External ID in Registration Accept

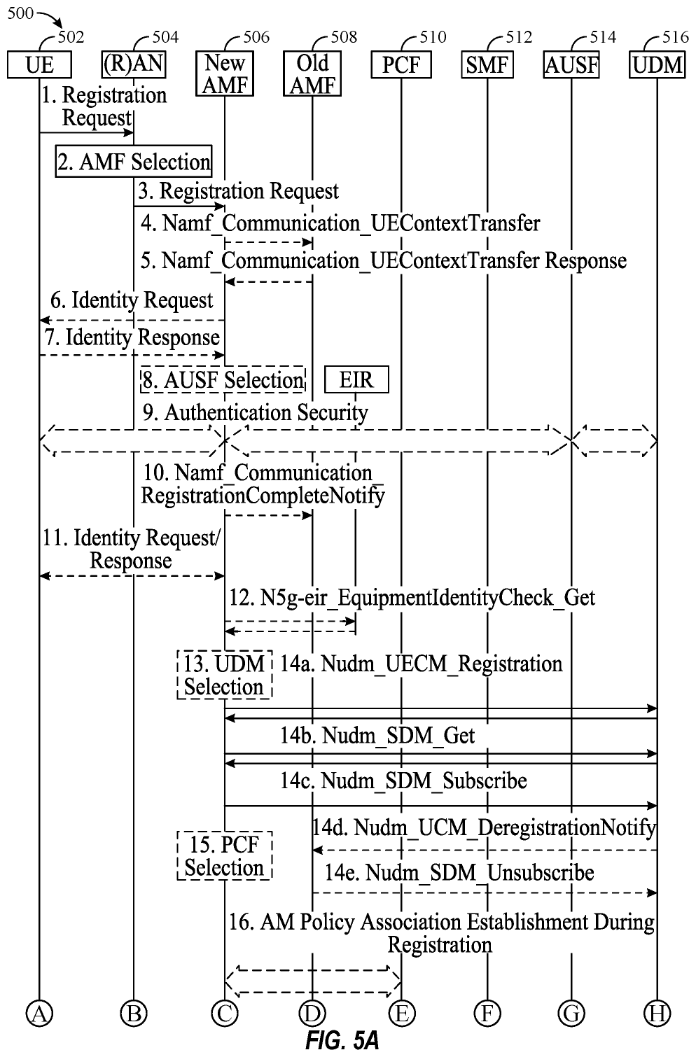

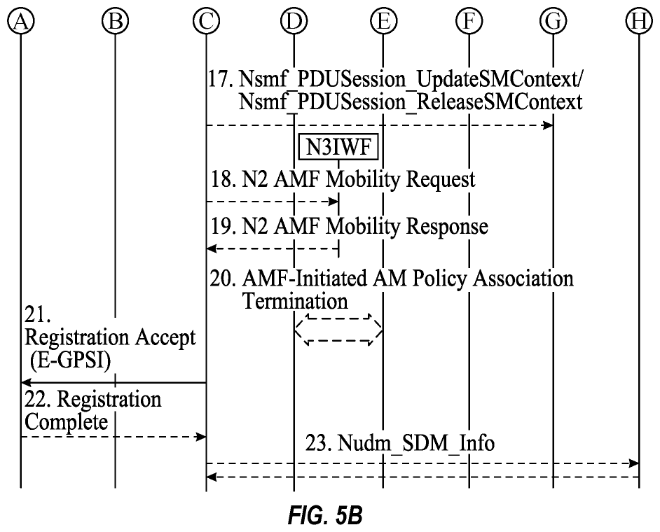

FIGS. 5A-5B depict an example call flow 500 for a UE 502 requesting a UE ID during a UE registration procedure, in accordance with aspects of the present disclosure. As shown in FIGS. 5A-5B, at step 1, UE 502 sends a registration request message to the RAN 504. At step, the RAN 504 selects an AMF and, at step 3, forwards the registration request message to the selected new AMF 506.

At steps 4 and 5, respectively, the new AMF 506 and the old AMF 508 optionally may transfer the UE context. At steps 6 and 7, respectively, the new AMF 506 optionally may request the UE identity and the UE 502 provides the identity response. At step 8, the new AMF 506 optionally may select the AUSF 514. At step 9, authentication and security optionally may be performed. At step 10, the new AMF 506 notifies the old AMF 508 that registration is completed. At step 11, the UE 502 and new AMF 506 optionally may exchange identity request and identity response. At step 12, the new AMF 506 optionally may interface with an equipment identity register (EIR). At step 13, the new AMF 506 optionally may select UDM 516.

At step 14a, the new AMF 506 registers with the UDM 516. At step 14b, the new AMF 506 retrieves the E-GPSI from the UDM 516 (e.g., using a Nudm_SDM_Get operation). At step 14c, the new AMF 506 sends a subscription message to the UDM 516.

At step 14d and 14e, respectively, the old AMF 508 optionally may sends a deregistration notification and unsubscribe message to the UDM 516. At step 15, the new AMF 506 optionally may select PCF 510. At step 16, the new AMF 506 optionally may establish an access and mobility (AM) policy association with PCF 510. At step 17, the new AMF 506 optionally may send an updates or release session management (SM) to SMF 512. At steps 18 and 19, respectively, the new AMF 506 optionally may exchange mobility accept and mobility response message with an interworking function (IWF). At step 20, the old AMF 508 optionally may terminate its AM policy association with PCF 510.

At step 21, the new AMF 506 send a registration accept message to the UE 502. In some aspects the UE ID (e.g., GPSI or E-GPSI) is included in the registration accept message. In some aspects, the registration accept message at step 21 includes one or more of: a 5G global unique temporary identifier (GUTI), a registration area, one or more GPSIs, mobility restrictions, PDU session status, allowed network slice selection assistance information (NSSAI), mapping of allowed NSSAI, configured NSSAI for the serving PLMN, mapping of configured NSSAI, network slice selection resource group (NSSRG) information, rejected single NSSAIs (S-NSSAIs), pending NSSAI, mapping of pending NSSAI, periodic registration update timer, active time, strictly periodic registration timer indication, local area data network (LADN) information, accepted mobile originated connection only (MICO) mode, IMS Voice over PS session supported indication, emergency service support indicator, accepted discontinuous reception (DRX) parameters for E-UTRA and NR, accepted DRX parameters for narrowband IoT (NB-IoT), extended idle mode DRX parameters, paging time window, network support of interworking without N26, access stratum connection establishment NSSAI inclusion mode, network slicing subscription change indication, operator-defined access category definitions, list of equivalent PLMNs, enhanced coverage restricted information, supported network behaviour, service gap time, PLMN-assigned UE radio capability ID, PLMN-assigned UE radio capability ID deletion, wake up signal (WUS) assistance information], AMF public emergency information public safety (PEIPS) assistance information, truncated 5G shortened temporary mobile subscriber identity (5G-S-TMSI) configuration, connection release supported, paging cause indication for voice service supported, paging restriction supported, reject paging request supported, paging restriction information acceptance/rejection, list of PLMN(s) to be used in disaster condition, disaster roaming wait range information, and/or disaster return wait range information.

At step 22, the UE 502 optionally may send a registration complete message to the new AMF 506. At step 23, the new AMF 506 optionally may send an acknowledgement to UDM 516.

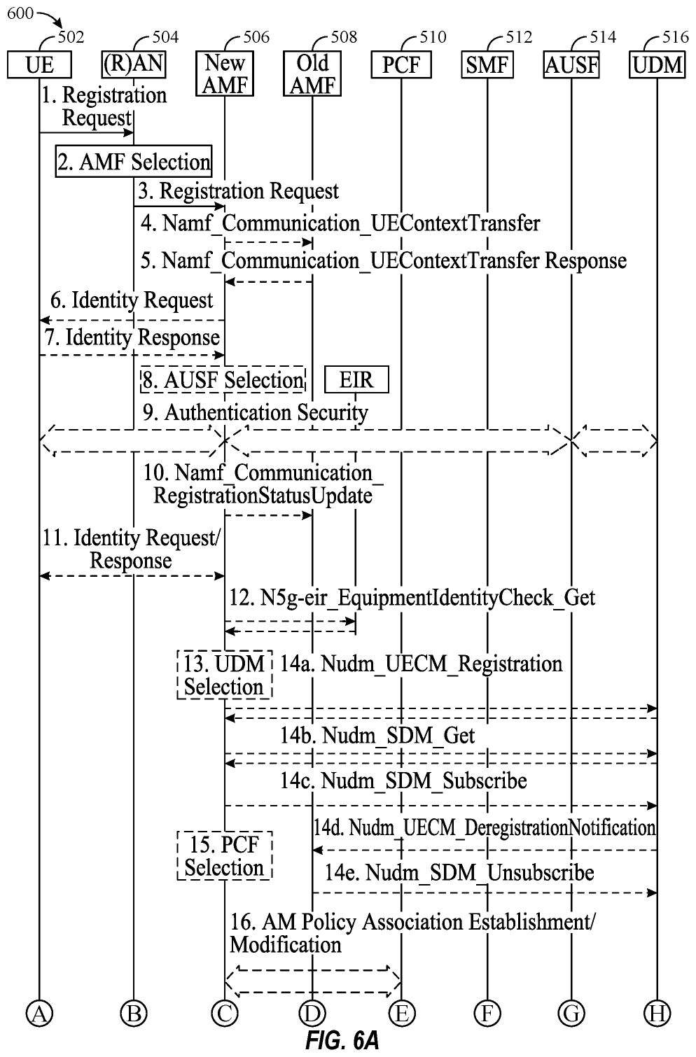

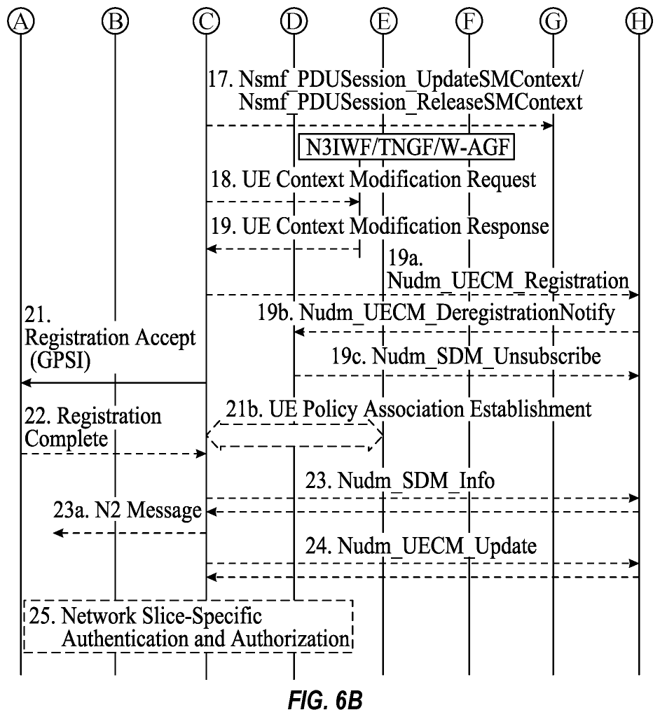

In aspects, the registration and subscription messages at steps 14a-14c may be an optional, used for some UEs (e.g., for edge application enabled UEs) and may be an optional information element (IE) that is included only if requested by the UE as shown in FIGS. 6A-6B. In some aspects, at step 1, the registration request message from the UE 502 to the RAN 504 includes a “UE ID request” indication which is forwarded by the RAN 504 to the AMF 506 in step 3. At step 21, the new AMF 506 includes the UE ID in the registration accept message to the UE 502 in response to the request. In some aspects, the registration request message includes one or more of registration type, subscriber concealed identifier (SUCI), 5G-GUTI, PEI, UE ID request, last visited tracking area identity (TAI), security parameters, requested NSSAI, mapping of requested NSSAI, default configured NSSAI indication, UE radio capability update, UE MM core network capability, PDU session status, list of PDU sessions to be activated, follow-on request, MINO mode preference, requested active time, requested DRX parameters for E-UTRA and NR, requested DRX parameters for NB-IoT, extended idle mode DRX parameters], LADN DNN(s) or indicator of requesting LADN information, NAS message container, support for restriction of use of enhanced coverage, preferred network behaviour, UE paging probability information, paging subgrouping support indication, UE policy container (the list of PDU session identities (PSIs), indication of UE support for access network discovery and selection policy (ANDSP) and the operating system identifier, UE radio capability ID, release request indication, paging restriction information, PEI, and/or PLMN with disaster condition.

### UE External ID in PDU Session Establishment

According to certain aspects, the UE transmits the request for the UE ID to the core network in a Protocol Data Unit (PDU) session establishment request to the SMF of the CN and receives the external UE ID (e.g., GPSI or E-GPSI) from the CN as part of the PDU session establishment accept message. In some aspects, the UE transmits the request for the UE ID to the CN in a PDU session modification request to the SMF of the CN and receives the external UD ID (e.g., GPSI or E-GPSI) from the CN as part of the PDU session modification command message.

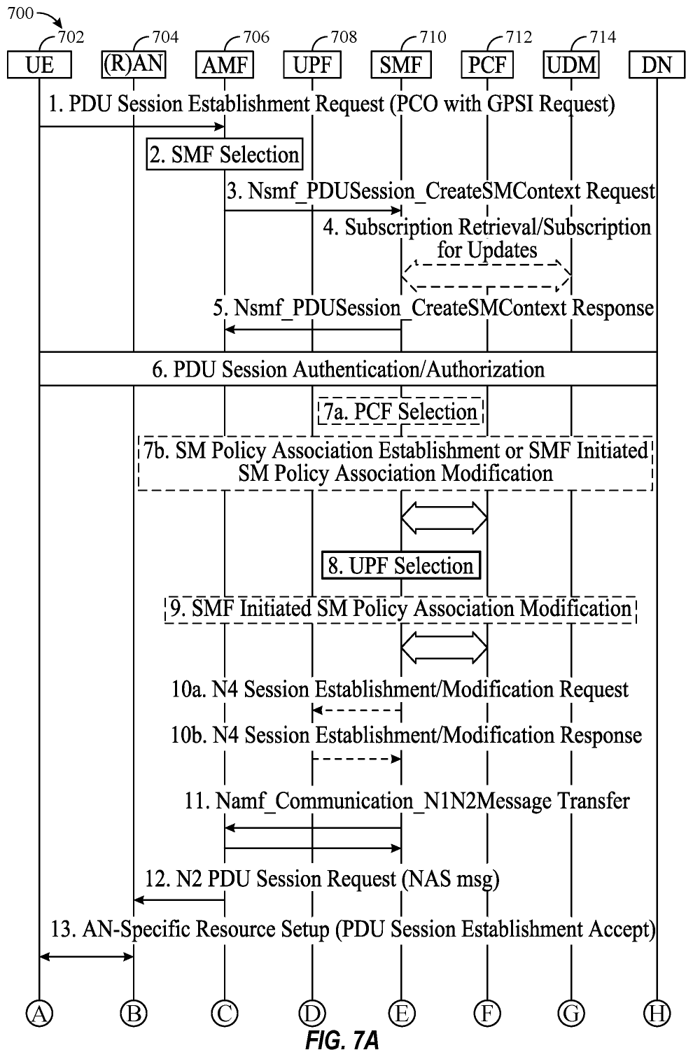

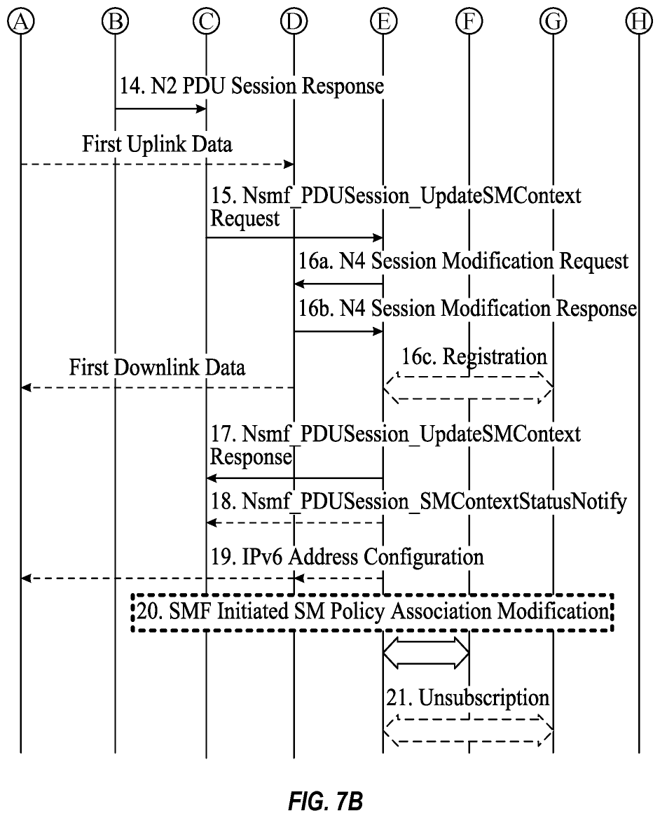

FIGS. 7A-7B is an example call flow 700 for a UE 702 requesting a UE ID during a PDU session establishment. As shown in FIGS. 7A-7B, at step 1, the UE 702 sends PDU session establishment request message to the AMF 706. In some aspects, the PDU session establishment request message includes S-NSSAI(s), UE requested DNN, PDU session ID, request type, old PDU session ID, N1 SM container, PDU session establishment request, and/or port management information container. In some aspects, to establish a new PDU session, the UE 702 generates a new PDU session ID. In some aspects, the UE 702 initiates the UE requested PDU session establishment procedure by the transmission of a NAS message containing the PDU session establishment request within the N1 SM container. In some aspects, the PDU Session Establishment Request includes (e.g., in addition to or alternatively to the information above) a PDU session ID, a requested PDU session type, a requested session and service continuity (SSC) mode, 5GSM capability, protocol configuration options (PCO), SM PDU DN request container, number of packet filters, header compression configuration, UE integrity protection maximum data rate, always-on PDU session requested, RSN, and/or PDU session pair ID. In some aspects, the UE 702 indicates, in the PCO, that the UE 702 requests the UE ID. In some aspects, the PDU session establishment request message in step 1 includes a request for UE ID retrieval as part of Protocol Configuration Options (PCO) or extended PCO (ePCO).

At step 2, AMF 706 selects an SMF 710. At step 3, AMF 706 sends a request message to the SMF 710 to create a session management context.

At step 4, the SMF 710 retrieves the GPSI(s) of the UE 702 from the UDM 714 along with the subscription data, for example, if the UE 702 indicated in the PCO that it requests the UE ID. In certain aspects, if the request for UE ID is received by the SMF 710 in the request, the SMF 710 includes the UE's GPSI the reply sent to the UE 702 through RAN 704 in step 13. In certain aspects, if the UE 702 indicated in the PCO that the UE 702 supports the ability to receive ECS addresses via NAS, the SMF 710 also includes UE's GPSI(s) along with the ECS address configuration information in the reply sent to the UE 702 through RAN 704 in step 13.

At step 5, the SMF 710 responds to the AMF 706 with the SM context response. At step 6, PDU session authentication and authorization is performed. At step 7a, SMF 710 may optionally select PCF 712. At step 7b, SM policy association establishment or SMF initiated SM policy association modification may be done. At step 8, SMF 710 selects UPF 708. At step 9, SMF initiated SM policy association modification optionally may be performed by SMF 710 and PCF 712. At steps 10a and 10b, SMF 710 and UPF 708 optionally may exchange N4 session establishment/modification request and response messages.

At step 11, SMF 710 and AMF 706 exchange Namf_Communication_NIN2 message transfer. In some aspects, the Namf_Communication_NIN2 message transfer includes one or more of PDU session ID, N2 SM information (e.g., PDU Session ID, quality-of-service (QoS) profile(s), one or more QoS flow identifiers (QFIs), CN tunnel info, S-NSSAI from the allowed NSSAI, session aggregate maximum bit rate (AMBR), PDU session type, user plane security enforcement information, UE integrity protection maximum data rate, RSN, and/or PDU session pair ID), and/or N1 SM container (e.g., PDU session establishment accept, QoS rule(s), QoS flow level QoS parameters, selected SSC mode, S-NSSAI(s), UE Requested DNN, allocated IPv4 address, interface identifier, Session-AMBR, selected PDU Session Type, reflective QoS Timer, proxy call session control function (P-CSCF) address(es), control plane only indicator, header compression configuration, always-on PDU session granted, small data rate control parameters, small data rate control status, serving PLMN rate control, PVS fully qualified domain name (FQDN), and/or PVS IP address).

At step 12, AMF 706 forwards a N2 PDU session request to the RAN 704. At step 13, RAN 704 sends a PDU session establishment accept message to UE 702. At step 14 RAN 704 sends a N2 PDU session response to AMF 706 and UE 702 may send uplink data to UPF 708. At step 15, AMF 706 sends an update SM context request to SMF 710. At step 16a, SMF 710 sends an N4 session modification request to UPF 708. At step 16b, UPF 708 sends an N4 session modification response to SMF 710. At step 16c, SMF 710 may perform registration and downlink data can be sent from UPF 708 to UE 702. At step 17, SMF 710 sends an update SM context response to AMF 706. At step 18, SMF 710 sends an SM context status notify to AMF 706. At step 19, SMF 710 may sends an IPv6 address configuration to UPF 708, which UPF 708 forward to UE 702. At step 20, SMF 710 may initiate SM policy association modification. At step 21, SMF 710 may unsubscribe.

### UE External ID in Service-Level Authentication and Authorization Procedure

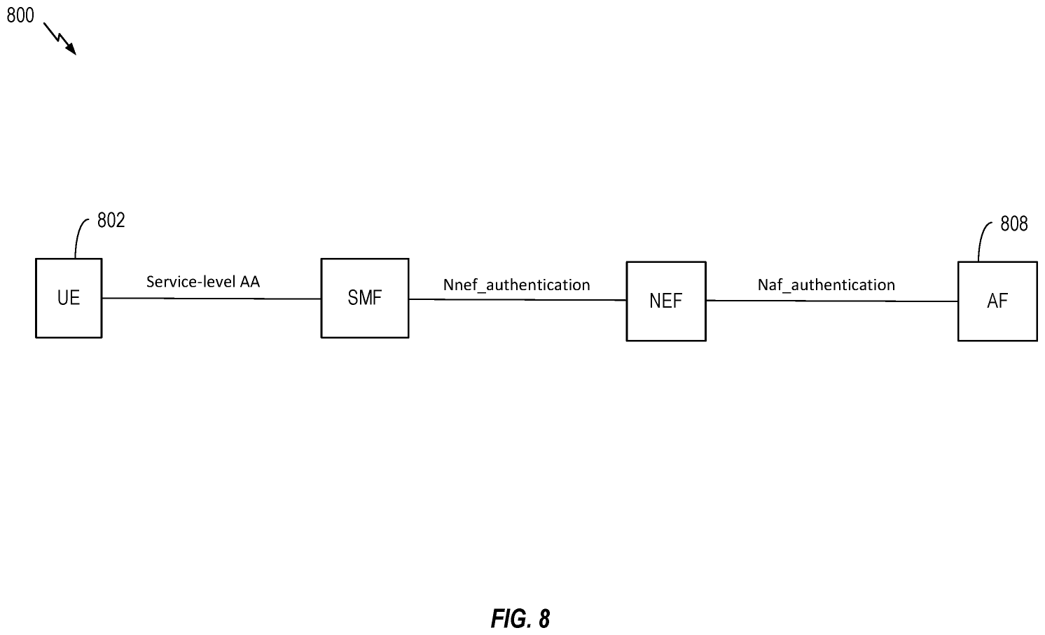

FIG. 8 illustrates an example AA procedure 800 of a UE 802 requesting a UE ID using a service level AA procedure, in accordance with aspects of the present disclosure. The service level AA can be performed during PDU session establishment and modification (e.g., at step 6 shown in FIG. 7A). The UE 802 includes the service-level device ID to initiate the service-level AA procedure. The AF 808 can provide new service-level device ID to the UE 802. In some aspects, the UE 802 performs the AA with ECS and EES.

In some aspects, the UE 802 and/or the CN does not know ECS addresses at the time of the PDU session establishment request. The UE 802 can include ECS address as a service-level AA server address in the service level AA container (SLAC) if the UE 802 is aware of the ECS address. In some aspects, the SLAC includes one or more of the service-level device ID, the service-level-AA server address, the service-level-AA response, the service-level-AA type, the service-level-AA pending indication, and/or the service-level-AA payload. If the UE 802 is not aware of the ECS address, the AA procedure 800 may be triggered by a PDU session modification procedure.

In some aspects, if the AA procedure 800 fails, the UE 802 cannot use the PDU session. Not being able to use a PDU session may cause an issue if the UE 802 is using an internet PDU session for an edge application (e.g., EDGEAPP) or if the UE 802 is using common PDU session for multiple services, the other services (not EDGEAPP related) are interrupted.

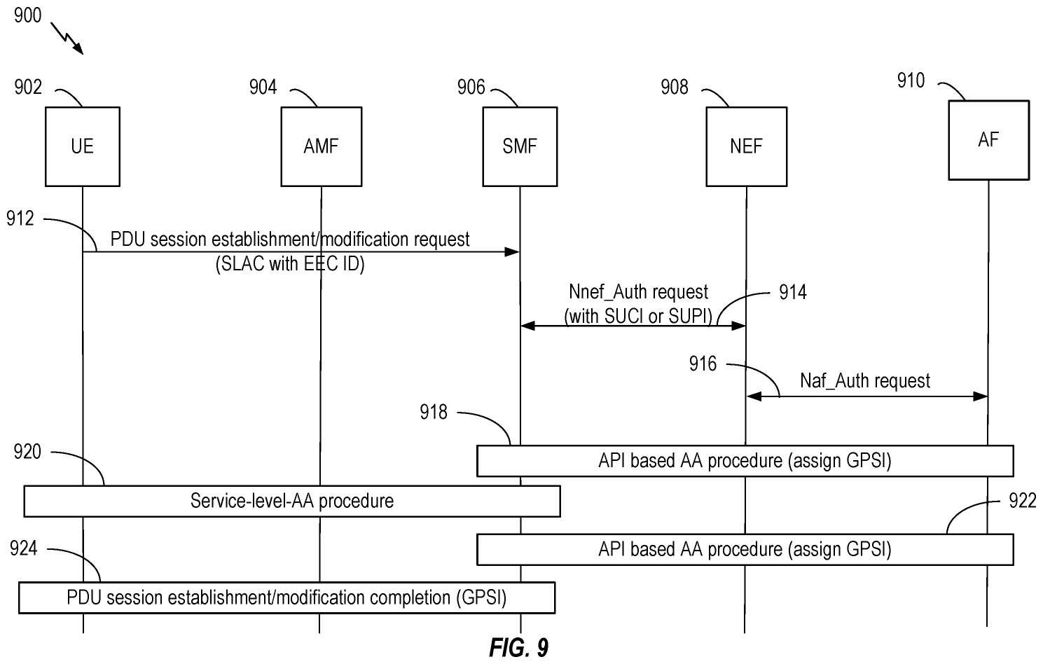

FIG. 9 is an example call flow 900 of a UE 902 requesting a UE ID using a service level AA procedure, in accordance with aspects of the present disclosure. At step 912, when the UE 902 requests establishing or modifying a PDU session for edge services, the UE 902 sends an SLAC including the service-level device ID set to the EEC ID to SMF 906.

According to aspects of the present disclosure, the SMF 906 includes the SUCI or the SUPI in the Nnef_Auth API to the NEF 908 so that the NEF identifies the UE. During the AA procedure at 918 or 922, the NEF 908 assigns the GPSI (e.g., E-GPSI) for the service if the GPSI is requested by the AF 910. The AF 910 requests GPSI for the UE 902 from the NEF 908 during Naf_Auth API operation. Alternately, if there is a single GPSI in the UE subscription, the NEF 908 may decide to provide the single GSPI, as there may be no need to assign new one. If there is a list of GPSIs in the UE subscription and if the NEF 908 can determine the corresponding GPSI for the AF request, the NEF 908 provides the corresponding GPSI. If NEF 908 cannot determine the corresponding GPSI for the AF request, the NEF 908 may assign a new GPSI.

In some aspects, after the NEF 908 determines to assign the GPSI to the UE 902, the NEF 908 requests a GPSI allocation from the UDM for the requested AF 910. The NEF 908 provides the assigned GPSI to the AF 910.

After a successful AA procedure, the AF 910 sends the AA result as well as the received GPSI (as a service-level device ID) to the UE through the CN, for example, at steps 922 and 924.

In some aspects, as an alternate to using the service-level device ID, the payload or new IEs dedicated for the purpose of obtaining and providing GPSI may be used. The UE 902 passes the received service-level device ID (e.g., GPSI) assigned by NEF 908 to the upper layer (e.g., to the EEC) and the upper layer uses the ID for EDGE-1 or EDGE-4 APIs (e.g., after step 924, not illustrated).

In some aspects, a specific policy indication may require that a PDU session shall not be released or rejected even if the AA procedure fails (in case of the PDU session is used for multiple services). The policy may be indicated by the AF 910 (e.g., in Naf_Auth API) or indicated by the NEF 908 (e.g., based on operator policy) to the SMF 906, such that the SMF 906 can take appropriate action.

### UE External ID in AKMA Procedure

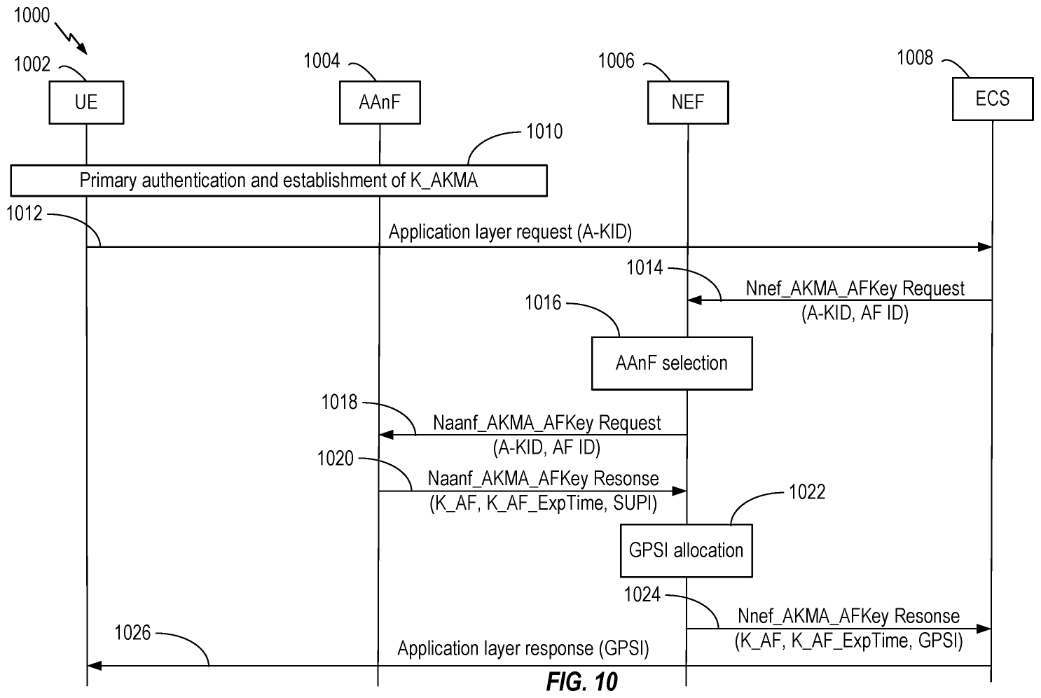

FIG. 10 is an example call flow 1000 for assigning a UE ID during an AKMA procedure, in accordance with aspects of the present disclosure. As illustrated in FIG. 10, the NEF assigns the UE ID during AKMA procedure, and ECS provides UE with the assigned UE ID.

At step 1010, primary authentication and establishment of the AKMA key, K_{AKMA}, is performed. At step 1012, UE 1002 sends an application layer request to ECS 1008 including an AKMA key identifier (A-KID). In some aspects, the application layer request is a service provisioning request or an EEC registration request (sent to EES).

At step 1014, ECS 1008 sends an Nnef_{AKMA_AFKey} key request to NEF 1006. At step 1016, NEF 1006 selects AKMA anchor function (AAnF) 1004 and, at step 1018, NEF 1006 sends an N_{AAnF_AKMA_AFKey} request to the AAnF 1004 including the A-KID and AF ID. At step 1020, AAnF 1004 responds with N_{AAnF_AKMA_AFKey} response including the AKMA application key (K_{AF}), expiry of the K_{AF} (K_{AF_ExpTime}), and the SUPI.

At step 1022, NEF 1006 allocates the GPSI (e.g., E-GPSI) for UE 1002. In some aspects, the GPSI is assigned per UE (not per EEC). In some aspects, after receiving K_{AF} and SUPI at step 1020, the NEF 1006 requests the GPSI allocation from the UDM for the requested AF. In some aspects, the AF requests the NEF 1006 to assign a GPSI in the Nnef_AKMA_AFKey_request.

In some aspects, if NEF 1006 assigns a new GPSI, the NEF 1006 invokes a new UDM exposed API to inject the GPSI into the UE subscription information so that NFs can identify the UE 1002 when external exposure API is invoked. Alternatively, once the NEF 1006 determines to assign the GPSI, the NEF 1006 may request a GPSI (e.g., E-GPSI) allocation from the UDM for the requested AF.

In some aspects, if there is a UE ID in the UE subscription, the NEF 1006 may decide to provide the existing GPSI. If there are a list of GPSIs in the UE subscription and if the NEF 1006 can determine the corresponding GPSI for the AF request, the NEF 1006 provides the corresponding GPSI. If NEF 1006 cannot determine the corresponding GPSI for the AF request, the NEF may assign a new GPSI.

At step 1024, the NEF 1006 sends an Nnef_{AKMA_AFKey} key response to ECS 1008 including the KAF, K_{AF_ExpTime}, and GPSI. In some aspects, once the AF (e.g., ECS 1008) receives the GPSI, the can distribute the GPSI and EEC ID pair to relevant EESs. In some aspects, the EES may query the ECS for the GPSI using the EEC ID as a query parameter.

At step 1026, ECS 1008 provides the GPSI to the UE 1002 in response to the application layer request. If the AF is an EES, the AF provides the GPSI to the UE 1002 as a response of EES registration request.

In some aspects, once the UE 1002 (e.g., the EEC) receives the GPSI from the EEL network entity (e.g., the ECS 1008), the EEC stores the GPSI associated with the ECSP where the EEL network entity belongs, and the EEC may provide the application client with the GPSI (e.g., E-GPSI as an EDGE UE ID).

In some aspects, a Nudm_{SubscriberDataManagement} message includes subscription data types including access and mobility subscription data and session management subscription data. In some aspects, both access and mobility subscription data and session management subscription data contain a GPSI list.

### UE External ID Verification

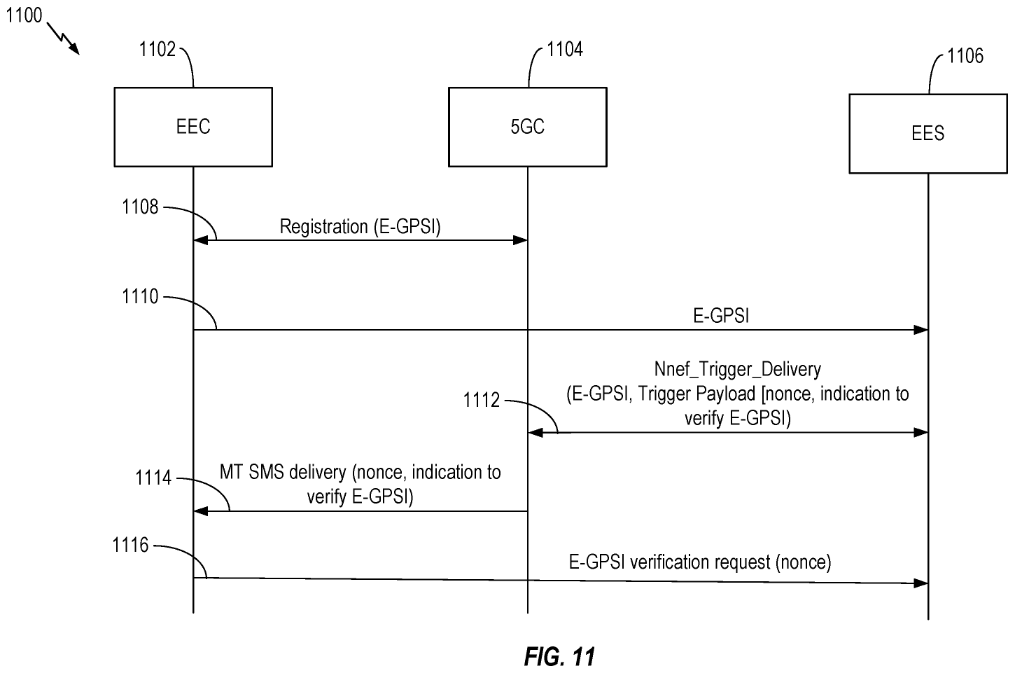

FIG. 11 is an example call flow 1100 showing a procedure for verifying UE provided UE ID (e.g., E-GPSI).

As shown, at step 1108, the UE (e.g., EEC 1102) registers with the 5GC 1104 and obtains the E-GPSI. For example, the E-GPSI may be provided to the EEC 1102 in a registration accept message (e.g., as shown in FIGS. 4-6). At step 1110, the EEC 1102 provides the E-GPSI to EES 1106.

To verify that the EEC 1102 provided UE ID (e.g., E-GPSI) actually belongs to the UE, the Nnef_Trigger_Delivery service may be used. As shown, at steps 1112-1114, the EES 1106 uses the Nnef_Trigger_Delivery service, sending a nonce to the EEC 1102 via the 5GC 1104, indicating to verify the E-GPSI. At step 1114, EEC 1102 receives the nonce only if the UE ID that the EEC 1102 provided in step 1108 belongs to the UE. At step 1116, EEC 1102 sends the nonce to the EES 1106 verifying that the EEC 1102 received the nonce and, therefore, that the UE ID provided by the EEC 1102 to the EES 1106 belongs to the UE. In some aspects, the nonce may be replaced with an authorization token. In this case, the UE may support SMS over NAS.

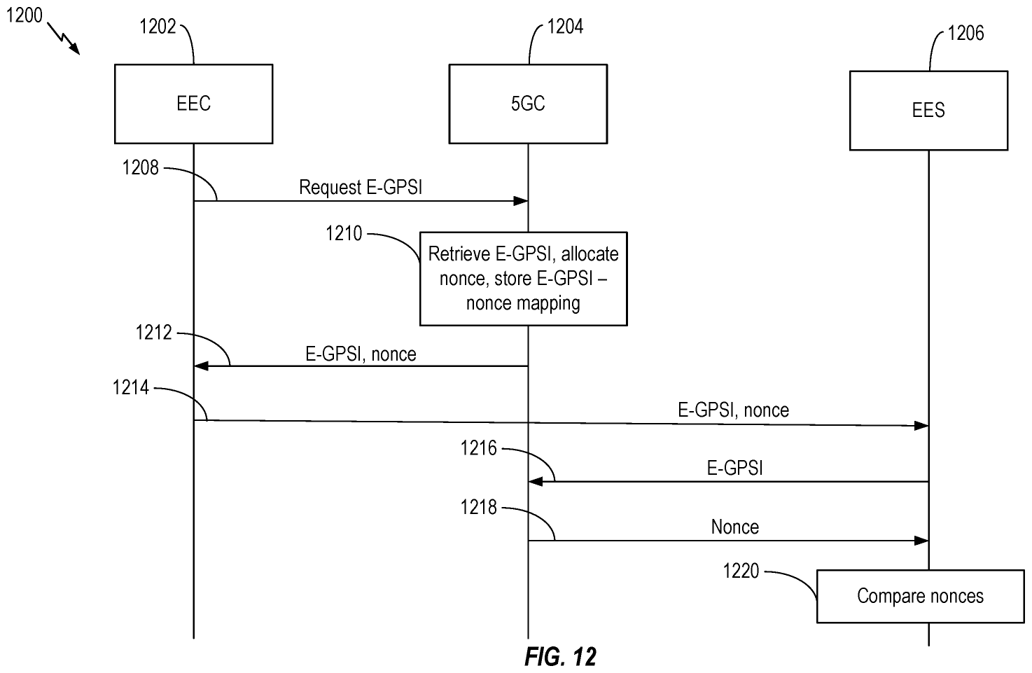

FIG. 12 is an example call flow showing a procedure 1200 for verifying the UE provided UE ID, in accordance with aspects of the present disclosure. As shown, at step 1208, the EEC 1202 provides a request to the 5GC 1204. In some aspects, the E-GPSI is requested in a registration request (e.g., as shown in FIGS. 4-6). In some aspects, the E-GPSI is requested in a PDU session establishment message (e.g., as shown in FIG. 7A). At step 1210, the 5GC 1204 retrieves the E-GPSI, allocates a nonce, and stores a mapping of the E-GPSI to nonce. At step 1212, the 5GC 1204 provides the E-GPSI and the nonce to EEC 1202. At step 1214, the EEC 1202 provides the E-GPSI and the nonce to the EES 1206. At 1216, the EES 1206 sends the E-GPSI received from the EEC 1202 to the 5GC 1204. At step 1218, the 5GC 1204 returns the nonce associated with the E-GPSI in the stored mapping to the EES 1206. At step 1220, the EES 1206 compares the nonce sent from the UE (i.e., the nonce received from the EEC 1202 at step 1214) to the nonce sent from the 5GC at step 1218. In some aspects, the nonce may be replaced with an authorization token. Based on the comparison, the EES 1206 verifies the UE provided E-GPSI.

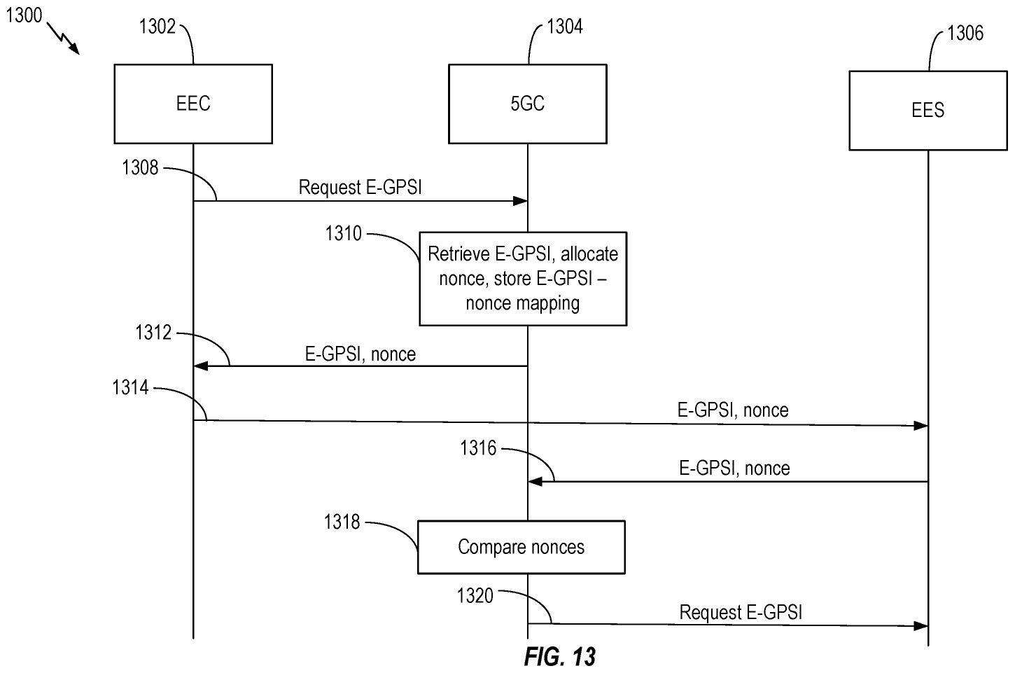

FIG. 13 is an example call flow showing a procedure 1300 for verifying the UE provided UE ID. As shown, at step 1308, the EEC 1302 provides a request to the 5GC 1304. In some aspects, the E-GPSI is requested in a registration request (e.g., as shown in FIGS. 4-6). In some aspects, the E-GPSI is requested in a PDU session establishment message (e.g., as shown in FIGS. 7A-7B). At step 1310, the 5GC 1304 retrieves the E-GPSI, allocates a nonce, and stores a mapping of the E-GPSI to nonce. At step 1312, the 5GC 1304 provides the E-GPSI and the nonce to EEC 1302. At step 1314, the EEC 1302 provides the E-GPSI and the nonce to the EES 1306. At 1316, the EES 1306 sends the E-GPSI received from the EEC 1302 to the 5GC 1304. At step 1318, the 5GC 1304 compares received from the EES 1306 at step 1316 to the nonce stored at step 1310. In some aspects, the nonce may be replaced with an authorization token. Based on the comparison, the 5GC 1304 verifies the UE provided E-GPSI. At step 1320, 5GC 1304 can indicate to EES 1306 whether the E-GPSI is verified (e.g., OK/NOK).

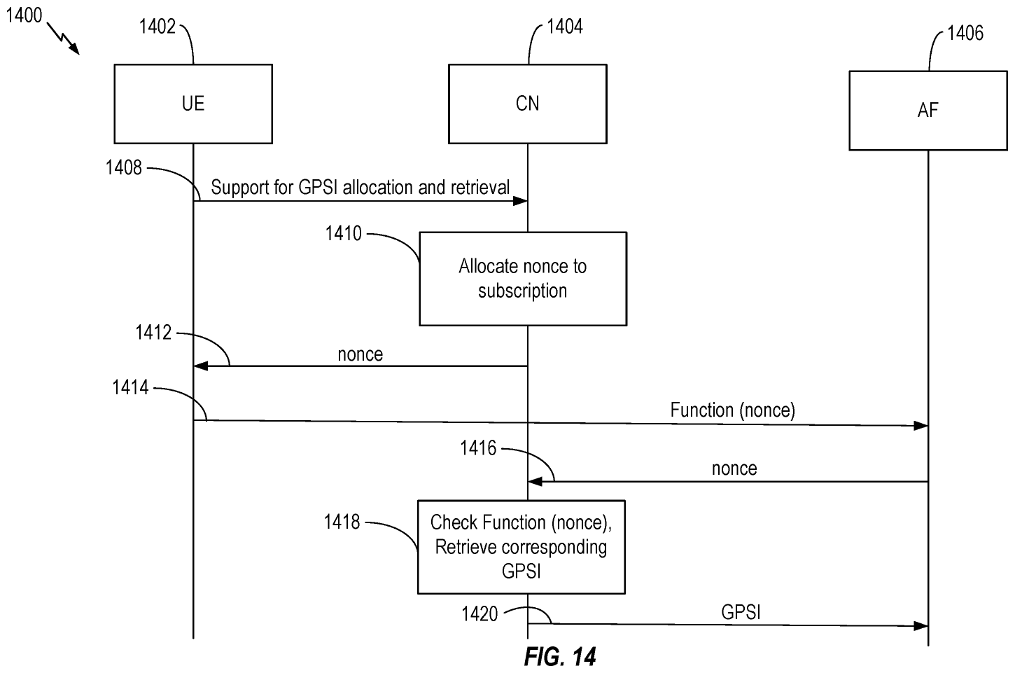

FIG. 14 is an example call flow of a procedure 1400 for an AF 1406 obtaining a GPSI from a CN 1404 based on the inputs provided by a UE 1402. As shown, at step 1408, the UE 1402 indicates support for UE ID (e.g., E-GPSI) allocation and retrieval to the CN 1404 (e.g., an SMF). At step 1410, the CN 1404 allocates a nonce to the subscription. In some aspects, the nonce is a Key ID and a Key. In some aspects, the Key ID and Key are used in AKMA procedures (e.g., as shown in FIG. 10). At step 1412, CN 1404 provides the nonce to UE 1402, which passes the nonce through a function and generate a result. In some aspects, the function is to generate a message authentication code. In some aspects, the UE 1402 uses application function information such as AF ID along with the nonce to generate the message authentication code. At 1414, the UE 1402 provides the result of the function and other related parameters, e.g., the Key ID, to the AF 1406. At step 1416, AF 1406 provides the nonce to the CN 1404. At 1418, the CN 1404 uses the nonce to retrieve the GPSI (e.g., E-GPSI) corresponding to the UE to which the nonce was allocated at step 1410. At step 1420, the CN 1404 provides the GSPI to the AF 1406, which can share it to the UE 1402.

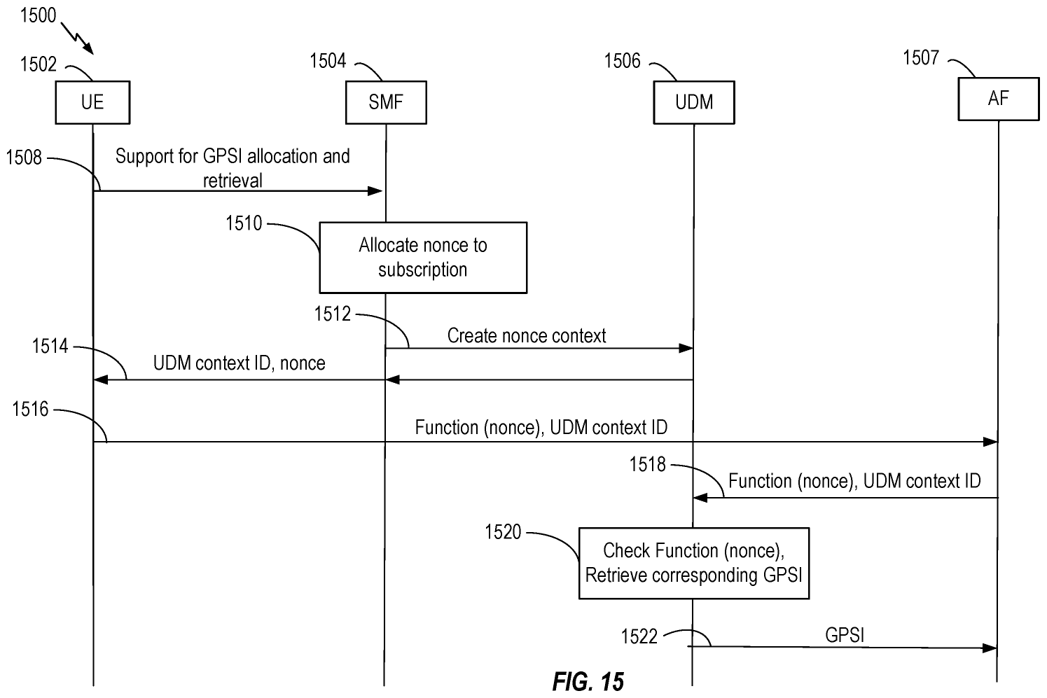

FIG. 15 is an example call flow of a procedure 1500 for an AF 1507 obtaining a GPSI (e.g., E-GPSI) from a CN based on the inputs provided by a UE 1502. As shown, at step 1508, the UE 1502 indicates support for UE ID (e.g., E-GPSI) allocation and retrieval to a core network function, for example SMF 1504. As 1510, SMF 1504 allocates a nonce to the subscription. At step 1512, SMF 1504 creates a context for this nonce in the UDM 1506, storing the context with the UE subscription. At step 1514, UDM 1506 provides a UDM context ID to the SMF 1504. In some aspects, the nonce is a Key and UDM context ID is a Key ID. In some aspects this Key and the Key ID is used in AKMA procedures. The SMF 1504 provides the nonce and the UDM context ID back to the UE 1502. At step 1516, the UE 1502 passes the nonce through a function and generate a result (e.g., generates a message authentication code) and provides the result of the function and UDM context ID to the AF 1507. At step 1518, AF 1508 provides the UE provided information to the UDM 1506 which uses the information, at step 1520, to retrieve the GPSI (e.g., E-GPSI) related to the UE to which the nonce was allocated. At step 1522, the UDM 1506 then provides the GSPI to the AF 1507, which can share the GPSI to the UE 1502.

According to certain aspects, the techniques described herein enable the UE to retrieve its External ID (e.g., the E-GPSI) later used to identify the UE at the edge application layer, irrespective of whether NAT is deployed or not. For example, the external ID can be used to initiate an application context relocation (ACR) procedure.

### Example Operations by a User Equipment

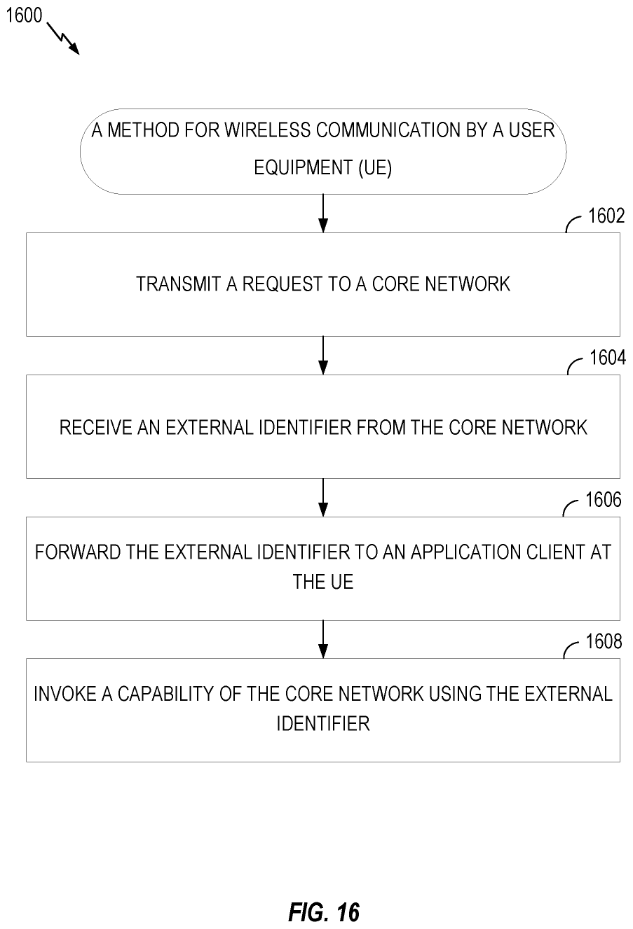

FIG. 16 is an example call flow diagram illustrating operations 1600 for wireless communication, in accordance with certain aspects of the present disclosure. The operations 1600 may be performed, for example, by a UE (e.g., such as the UE 120a in the wireless communication network 100) for receiving an UE ID. The operations 1600 may be implemented as software components that are executed and run on one or more processors. Further, the transmission and reception of signals by the UE in operations 1600 may be enabled, for example, by one or more antennas. In certain aspects, the transmission and/or reception of signals by the UE may be implemented via a bus interface of one or more processors obtaining and/or outputting signals.

Operations 1600 may begin, at operation 1602 by the UE transmitting a request to a CN. At operation 1604, the UE receives an external identifier (e.g., E-GPSI) from the CN in response to the request. At operation 1606, the UE transmits the external identifier to an application client at the UE. At operation 1608, the UE invokes capability of the CN using the external identifier.

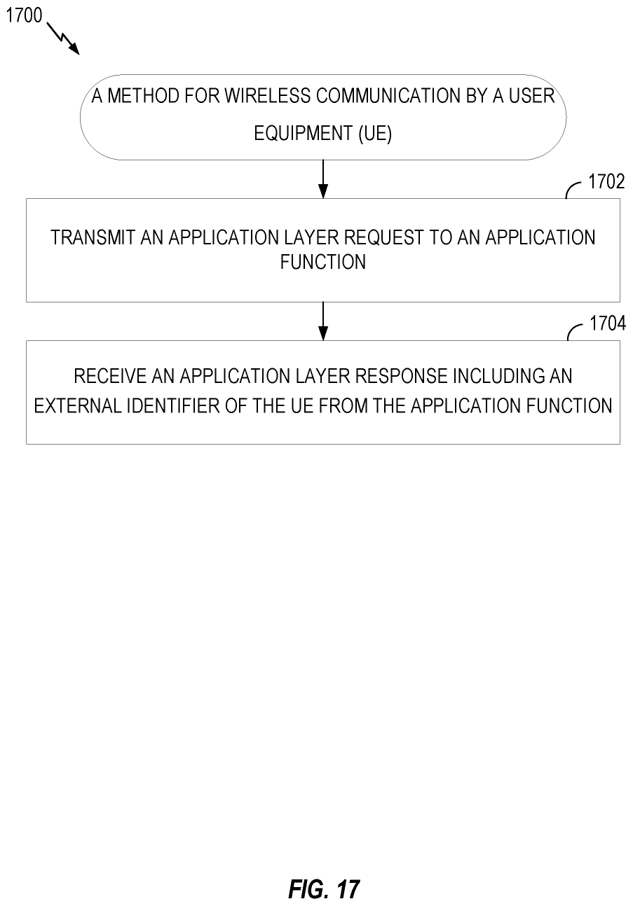

FIG. 17 is a flow diagram illustrating example operations 1700 for wireless communication, in accordance with certain aspects of the present disclosure. The operations 1700 may be performed, for example, by a UE (e.g., such as the UE 120a in the wireless communication network 100) for UE-initiated de-registration. The operations 1700 may be implemented as software components that are executed and run on one or more processors. Further, the transmission and reception of signals by the UE in operations 1700 may be enabled, for example, by one or more antennas. In certain aspects, the transmission and/or reception of signals by the UE may be implemented via a bus interface of one or more processors (obtaining and/or outputting signals.

At 1702 by the UE transmits an application layer request to an AF. While not a UE operation, at 1704, the AF receives an external identifier (e.g., E-GPSI) from a NEF of a CN. At 1506, the UE receives an application layer response including external identifier from the AF.

### Example Communications Device

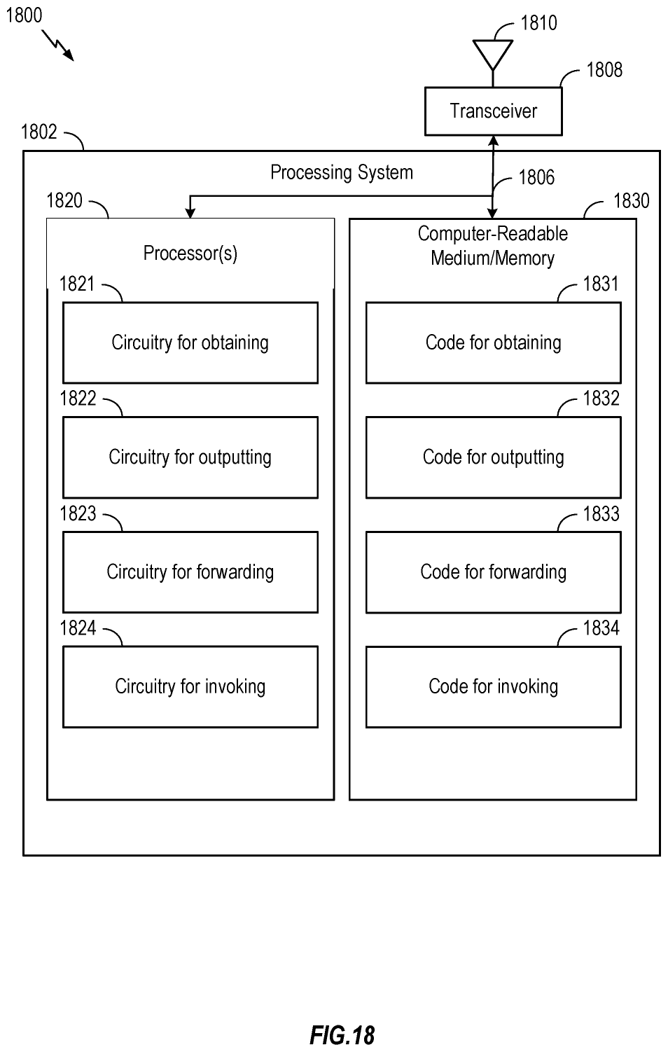

FIG. 18 depicts aspects of an example communications device 1800. In some aspects, communications device 1800 is a user equipment, such as a UE 104 described above with respect to FIGS. 1 and 3.

The communications device 1800 includes a processing system 1802 coupled to a transceiver 1808 (e.g., a transmitter and/or a receiver). The transceiver 1808 is configured to transmit and receive signals for the communications device 1800 via an antenna 1810, such as the various signals as described herein. The processing system 1802 may be configured to perform processing functions for the communications device 1800, including processing signals received and/or to be transmitted by the communications device 1800.

The processing system 1802 includes one or more processors 1820. In various aspects, the one or more processors 1820 may be representative of one or more of receive processor 358, transmit processor 364, TX MIMO processor 366, and/or controller/processor 380, as described with respect to FIG. 3. The one or more processors 1820 are coupled to a computer-readable medium/memory 1830 via a bus 1806. In certain aspects, the computer-readable medium/memory 1830 is configured to store instructions (e.g., computer-executable code) that when executed by the one or more processors 1820, cause the one or more processors 1820 to perform the operations 1600 and/or operations 1700 described with respect to FIGS. 16-17, or any aspect related to it. Note that reference to a processor performing a function of communications device 1800 may include one or more processors performing that function of communications device 1800.

In the depicted example, computer-readable medium/memory 1830 stores code (e.g., executable instructions) for obtaining 1831, code for outputting 1832, code for forwarding 1833, and code for invoking 1834. Processing of the code 1831-1834 may cause the communications device 1800 to perform the operations 1600 and/or operations 1700 described with respect to FIGS. 16-17, or any aspect related to it.

The one or more processors 1820 include circuitry configured to implement (e.g., execute) the code stored in the computer-readable medium/memory 1830, including circuitry for obtaining 1821, circuitry for outputting 1822, circuitry for forwarding 1823, and circuitry for invoking 1824. Processing with circuitry 1821-1824 may cause the communications device 1800 to perform the operations 1600 and/or operations 1700 described with respect to FIGS. 16-17, or any aspect related to it.

Various components of the communications device 1800 may provide means for performing the operations 1600 and/or operations 1700 described with respect to FIGS. 16-17, or any aspect related to it. For example, means for transmitting, sending or outputting for transmission may include the transceivers 354 and/or antenna(s) 352 of the UE 104 illustrated in FIG. 3 and/or transceiver 1808 and antenna 1810 of the communications device 1800 in FIG. 18. Means for receiving or obtaining may include the transceivers 354 and/or antenna(s) 352 of the UE 104 illustrated in FIG. 3 and/or transceiver 1808 and antenna 1810 of the communications device 1800 in FIG. 18.

### EXAMPLE CLAUSES

Implementation examples are described in the following numbered clauses:

Clause 1: A method of wireless communication performed by a user equipment (UE), comprising transmitting a request to a core network; receiving an external identifier (GPSI) from the core network in response to the request; transmitting the GPSI to an application client at the UE; and invoking capability of the core network using the GPSI.

Clause 2: The method of Clause 1, wherein: the external identifier comprises an edge computing specific external identifier (E-GPSI); and transmitting the E-GPSI to the application client comprises in response to receiving the E-GPSI at an edge enabler layer of the UE.

Clause 3: The method of Clause 1, wherein the core network includes an Access and Mobility Management Function (AMF); transmitting the request to the core network comprises transmitting a UE registration request to the AMF of the core network; and receiving the GPSI from the core network comprises receiving the GPSI as part of a UE registration accept message.

Clause 4: The method of Clause 3, wherein transmitting the registration request to the AMF of the core network further comprises: transmitting a request for a UE identifier (ID) as part of the UE registration request.

Clause 5: The method of any of Clause 1-3 wherein: the core network includes a Session Management Function (SMF); and transmitting the request to the core network further comprises transmitting a Protocol Data Unit (PDU) session establishment request message or a PDU session modification request message to the SMF of the core network; and receiving the GPSI from the core network comprises receiving the GPSI as part of a PDU session establishment accept message or of a PDU session modification command message.

Clause 6: The method of any of Clauses 1-5, wherein transmitting the PDU session establishment request or the PDU Session modification request message to the core network further comprises: transmitting a request for a UE identifier (ID) to the core network as part of a Protocol Configurations Options (PCO) information block of the PDU session establishment request or of the PDU session modification request message.

Clause 7: The method of any of Clauses 1-6, wherein receiving the GPSI further comprises receiving the GPSI as part of a PCO information block of the PDU session establishment accept message or of the PDU session modification command message.

Clause 8: The method of any of Clauses 1-7, wherein the external identifier comprises a edge computing specific external identifier (E-GPSI) and wherein receiving the E-GPSI from the core network comprises receiving the E-GPSI during a service-level authentication and authorization (AA) procedure.

Clause 9: The method of any of Clauses 1-8, further comprising including, by the UE, a service-level device Identifier (ID) to initiate the service-level AA procedure.

Clause 10: The method of any of Clauses 1-9, further comprising receiving a new service-level device ID set to the E-GPSI during the service-level AA procedure.

Clause 11: A method of wireless communication performed by a user equipment (UE), comprising transmitting an application layer request to an application function; and receiving an application layer response including an external identifier (GPSI) from the an application function.

Clause 12: The method of Clause 12, further comprising: including by the UE, Authentication and Key Management for Applications (AKMA) related details in the application layer request.

Clause 13: The method of any of Clauses 11-12, wherein GPSI is allocated by the NEF and received by the application function.

Clause 14: The method of any of Clauses 1-13, wherein the application layer request is one of a service provisioning request or, an Edge Enabler Client (EEC) registration request or an Edge Enabler Service (EAS) discovery request; and the application layer response is one of a service provisioning response or an EEC registration response or the EAS discovery response.

Clause 15: A processing system, comprising: a memory comprising computer-executable instructions; one or more processors configured to execute the computer-executable instructions and cause the processing system to perform a method in accordance with any one of Clauses 1-14.

Clause 16: A processing system, comprising means for performing a method in accordance with any one of Clauses 1-14.

Clause 17: A non-transitory computer-readable medium comprising computer-executable instructions that, when executed by one or more processors of a processing system, cause the processing system to perform a method in accordance with any one of Clauses 1-14.

Clause 18: A computer program product embodied on a computer-readable storage medium comprising code for performing a method in accordance with any one of Clauses 1-14.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment 104 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein, as well as other operations disclosed herein for performing the various techniques discussed herein for performing slice-aware network selection and/or performing UE-initiated de-registration.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method of wireless communication performed by a user equipment (UE), comprising:
transmitting a request message to a core network, the request message including a request for an identifier of the UE;
receiving a response message from the core network, the response message including an external identifier of the UE;
forwarding the external identifier to an application client at the UE; and
invoking a capability of the core network using the external identifier.

2. The method of claim 1, wherein the external identifier comprises an edge computing specific generic public subscription identifier (E-GPSI).

3. The method of claim 2, wherein forwarding the external identifier to the application client comprises forwarding the E-GPSI to the application client in response to receiving the E-GPSI at an edge enabler layer of the UE.

4. The method of claim 2, wherein:
transmitting the request message to the core network comprises transmitting a UE registration request message to an Access and Mobility Management Function (AMF); and
receiving the external identifier from the core network comprises receiving the E-GPSI from the AMF as part of a UE registration accept message.

5. The method of claim 2, wherein:
transmitting the request message to the core network comprises transmitting a Protocol Data Unit (PDU) session establishment request message or a PDU session modification request message to a Session Management Function (SMF); and
receiving the E-GPSI from the core network comprises receiving the E-GPSI from the SMF as part of a PDU session establishment accept message or of a PDU session modification command message.

6. The method of claim 5, wherein transmitting the PDU session establishment request message or the PDU session modification request message to the SMF comprises:
including the request for identifier of the UE to the SMF as part of a Protocol Configurations Options (PCO) information block of the PDU session establishment request message or of the PDU session modification request message.

7. The method of claim 6, wherein receiving the E-GPSI comprises receiving the E-GPSI as part of a PCO information block of the PDU session establishment accept message or of the PDU session modification command message.

8. The method of claim 2, wherein receiving the E-GPSI from the core network comprises receiving the E-GPSI during a service-level authentication and authorization (AA) procedure.

9. The method of claim 8, further comprising including, by the UE, a service-level device identifier (ID) to initiate the service-level AA procedure.

10. The method of claim 9, further comprising receiving a new service-level device ID set to the E-GPSI during the service-level AA procedure.

11. A method of wireless communication performed by a user equipment (UE), comprising:
transmitting an application layer request to an application function; and
receiving an application layer response from an application function, the application layer response including an external identifier of the UE.

12. The method of claim 11, further comprising including by the UE, Authentication and Key Management for Applications (AKMA) related information in the application layer request.

13. The method of claim 11, wherein the external identifier of the UE is an edge computing specific generic public subscription identifier (E-GPSI) allocated by a network exposure function (NEF).

14. The method of claim 11, wherein:
the application layer request is one of a service provisioning request, an Edge Enabler Client (EEC) registration request, or an Edge Enabler Service (EAS) discovery request; and
the application layer response is one of a service provisioning response, an EEC registration response, or an EAS discovery response.

15. A user equipment (UE), comprising:
one or more memories storing computer executable code; and
one or more processors coupled with the one or more memories and configured to execute the computer executable code and cause the UE to:
transmit a request message to a core network, the request message including a request for an identifier of the UE;
receive a response message from the core network, the response message including an external identifier of the UE;
forward the external identifier to an application client at the UE; and
invoke a capability of the core network using the external identifier.

16. The user equipment of claim 15, wherein the external identifier comprises an edge computing specific generic public subscription identifier (E-GPSI).

17. The user equipment of claim 16, wherein the one or more processors being configured to cause the UE to forward the external identifier comprises the one or more processors being configured to cause the UE to forward the E-GPSI to the application client in response to receiving the E-GPSI at an edge enabler layer of the UE.

18. The user equipment of claim 16, wherein:
the one or more processors being configured to cause the UE to transmit the request message to the core network comprises the one or more processors being configured to cause the UE to transmit a UE registration request message to an Access and Mobility Management Function (AMF); and
the one or more processors being configured to cause the UE to receive the external identifier from the core network comprises the one or more processors being configured to cause the UE to receive the E-GPSI from the AMF as part of a UE registration accept message.

19. The user equipment of claim 16, wherein:
the one or more processors being configured to cause the UE to transmit the request message to the core network comprises the one or more processors being configured to cause the UE to transmit a Protocol Data Unit (PDU) session establishment request message or a PDU session modification request message to a Session Management Function (SMF); and
the one or more processors being configured to cause the UE to receive the E-GPSI from the core network comprises the one or more processors being configured to cause the UE to receive the E-GPSI from the SMF as part of a PDU session establishment accept message or of a PDU session modification command message.

20. The user equipment of claim 19, wherein the one or more processors being configured to cause the UE to transmit the PDU session establishment request message or the PDU session modification request message to the SMF comprises the one or more processors being configured to cause the UE to include the request for identifier of the UE to the SMF as part of a Protocol Configurations Options (PCO) information block of the PDU session establishment request message or of the PDU session modification request message.

21. The user equipment of claim 20, wherein the one or more processors being configured to cause the UE to receive the E-GPSI comprises the one or more processors being configured to cause the UE to receive the E-GPSI as part of a PCO information block of the PDU session establishment accept message or of the PDU session modification command message.

22. The user equipment of claim 16, wherein the one or more processors being configured to cause the UE to receive the E-GPSI from the core network comprises the one or more processors being configured to cause the UE to receive the E-GPSI during a service-level authentication and authorization (AA) procedure.

23. The user equipment of claim 22, the one or more processors being configured to further cause the UE to include, by the UE, a service-level device identifier (ID) to initiate the service-level AA procedure.

24. The user equipment of claim 23, the one or more processors being configured to further cause the UE to receive a new service-level device ID set to the E-GPSI during the service-level AA procedure.

25. A user equipment (UE), comprising:
one or more memories storing computer executable code; and
one or more processors coupled with the one or more memories and configured to execute the computer executable code and cause the UE to:
transmit an application layer request to an application function; and
receive an application layer response from an application function, the application layer response including an external identifier of the UE.

26. The user equipment of claim 25, the one or more processors being configured to further cause the UE to include by the UE, Authentication and Key Management for Applications (AKMA) related information in the application layer request.

27. The user equipment of claim 25, wherein the external identifier of the UE is an edge computing specific generic public subscription identifier (E-GPSI) allocated by a network exposure function (NEF).

28. The user equipment of claim 25, wherein:
the application layer request is one of a service provisioning request, an Edge Enabler Client (EEC) registration request, or an Edge Enabler Service (EAS) discovery request; and
the application layer response is one of a service provisioning response, an EEC registration response, or an EAS discovery response.
